(19) United States
(12) Patent Application Publication
(10) Pub. No.: US 2003/0048177 A1
(43) Pub. Date: Mar. 13, 2003

(54) Power and signal common transmission device

(75) Inventor: Hung Yuan Chen, Jung Li City (TW)

Correspondence Address: BACON & THOMAS, PLLC, 625 SLATERS LANE, FOURTH FLOOR, ALEXANDRIA, VA, 22314

(73) Assignee: Global Sun Technology Inc.

(21) Appl. No.: 09/950,675

(22) Filed: Sep. 13, 2001

(51) Int. Cl. H04M 11/04

(52) U.S. Cl. 340/310.01

(57) ABSTRACT

A power and signal common transmission device comprises a power adapter, a wire case, a transmission cable and a switching regulator. The power adapter serves for transforming DC power into AC power. The wire case serves for transforming the power wire from the power adapter into output pins. The cable is connected from the wire case to the switching regulator. The switching regulator serves for dividing power and signal transmission path and decreasing a voltage of the input power. Therefore, the system is more stable and has a lower decay so that it can be used in a longer cable.

### BACKGROUND OF THE INVENTION

1. Field of the Invention

The present invention relates to transmissions of power and signals in a network substrate, and particularly to a power and signal common transmission device.

2. Description of the Related Art

Referring to FIG. 1, a prior art network connecting system is illustrated. A cable 4″ is outputted from the hub 1″ to a router/AP 6″. Furthermore, a power line 31″ induced from a power source 3″ is connected to the router/AP 6″.

The above structure is generally used in the prior art network connecting system. However, it is often that the power source is far away from the router/AP, but near the hub. If it is desired to transfer the power through such a long distance, it is very possible that the power suffers from a dramatic decay so that most of the power are consumed in the transmission path. Furthermore, currently, it is often too many wires, including power wires and signal wires, are disposed in a room disorderly. Not only a bad look is presented, but also some inconveniences is induced in for users.

To overcome above defect in the prior art, a technology is developed. Referring to FIG. 2, a signal wire 11′ is outputted from the hub 1′ and then is connected to a wiring case 2′. Power is input from an input end 31′ of a power adapter 3′, and then the DC power is transformed into AC power. Then, the DC power is outputted from an output end 32′ of the power adapter 3′. A wiring case 2′ near a hub 1, which has two inputs 21′, 22′. One input 11′ is from the hub 1′ and the other is from the output end 32′ of the power adapter 3′. In general a cable contains many wires which are formed as a bus wires, however, in signal transmission, not all the lines are used, namely, some wires are idles. Therefore, the idle wires may be used to transmit power. Thus, the power wires are integrated into the idle bus lines within the Cable 4′. Then, the cable is connected from an output end 23′ of the wire case 2′ to a lower drop out regulator 5′ (LDO regulator) near the access point. In the lower drop out regulator 5′, the input voltage is raised up to 24V or higher so as to reduce voltage drop and power consumption due to long distance delivering. The lower drop out regulator converts the higher voltage into 5V required by the router or access point. The lower drop out regulator 5′ has two end outputs, one is a signal output end 51′ and the other is a power output end 52′, and an input end 53 connected with the cable 4′. Signals are outputted from the signal output end 51′ and then is inputted to a signal input end 61′ of the router/AP 6. Similarly, power is outputted from the power output end 62′ and then is inputted to an power input end 62′ of the router/AP 6′.

However, this prior art using a lower drop out regulator has the defect of short transmission length of about 10 m to 20 m which is not practical in the current application. Moreover, the lower drop out regulator is not stable so that the quality of transmission signals are not preferred.

### SUMMARY OF THE INVENTION

Accordingly, the primary object of the present invention is to provide a power and signal common transmission device, wherein a network system with the present invention is more stable and has a lower decay so that it can be used in a longer cable. Therefore, the present invention is suitable to be used in the transmission of longer distance.

To achieve above objects, the present invention provides a power and signal common transmission device comprising a power adapter, a wire case, a transmission cable and a switching regulator.

The power adapter serves for transforming AC input power into DC output power, and power adapter has an input end for inputting a lower voltage power and an output end for output a high voltage power.

The wire case serves for transforming the power wire from the power adapter into an output pins which are originally used for signal bus wires; the wire case has two input ends, one for signal input, and the other for power input, and an output end being connected to the cable for transmission.

The cable is connected from the wire case to the switching regulator.

The switching regulator serves for dividing power and signal transmission path and decreasing a voltage of the input power; the switching regulator having an input from the cable and two output ends, one for power transmission and one for signal transmission;

The various objects and advantages of the present invention will be more readily understood from the following detailed description when read in conjunction with the appended drawing.

### BRIEF DESCRIPTION OF THE DRAWINGS

FIG. 1 shows a prior art power and signal transmission paths.

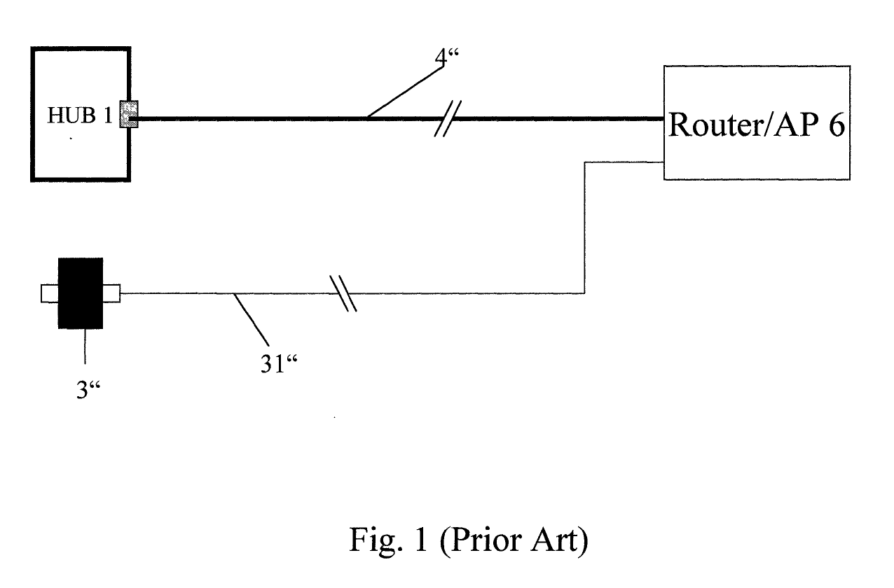

FIG. 2 shows another prior art power and signal transmission paths with a lower drop out regulator being used.

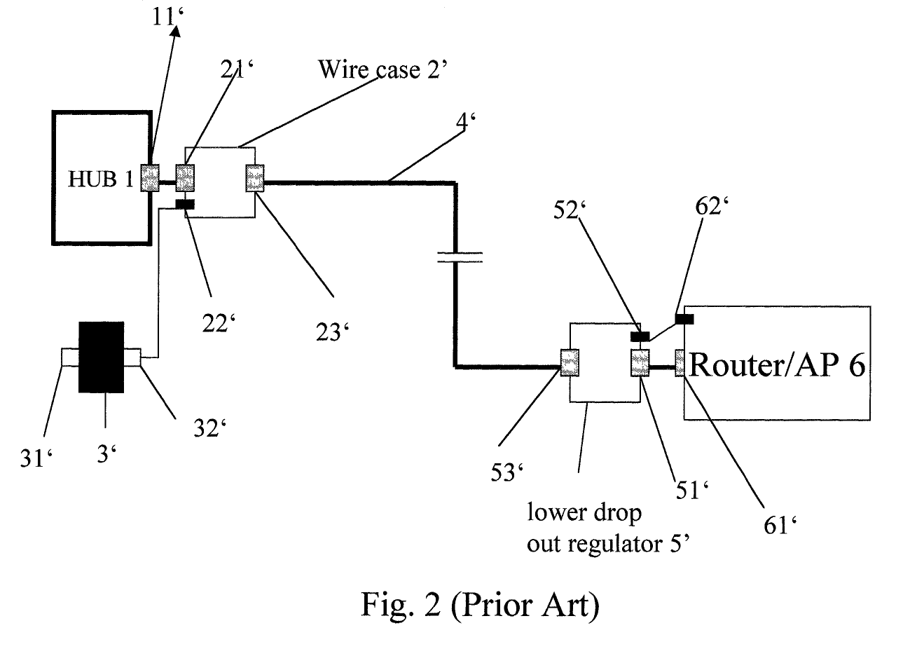

FIG. 3 shows the power and signal transmission paths of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

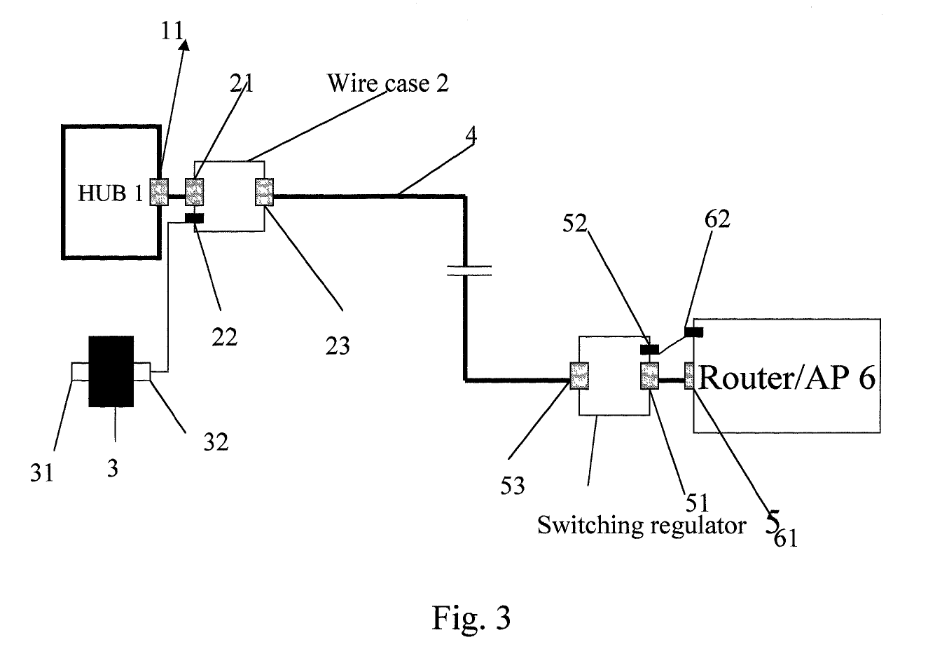

Referring to FIG. 3, a signal wire 11 is outputted from the hub 1 and then is connected to a wiring case 2. Power is input from an input end 31 of a power adapter 3, and then input AC power is transformed into DC power. Then, the DC power is outputted from an output end 32 of the power adapter 3. A wiring case 2 near a hub 1, which has 2 inputs 21, 22. One input 21 is from the hub 1 and the other input 22 is from the outputted end of the power adapter 3. In general, a cable contains many wires which are formed as a bus wires, however, in signal transmission, not all the lines are used, namely, some wires are idles. Therefore, the idle wires may be used to transmit power. Thus, in the present invention, the power wires are integrated into the idle bus lines within the Cable 4. Then, the cable is connected from an output end 23 of the wire case 2 to a switching regulator case 5 near the access point. The switching regulator case converts the higher voltage into 5V required by the router or access point. The switch regulator 5 has an input end 53 and two end outputs 51, 52, one is a signal output end 51 and the other is a power output end 52. Signals are outputted from the signal output end 51 and then is inputted to a signal input end 61 of the router/AP 6. Similarly, power is outputted from the power output end 52 and then is inputted to an power input end 62 of the router/AP 6. The product provides an optional power solution for remote Router or Access Point, instead of the 5V power adapter.

In the present invention, a switching regulator is used to replace a low drop out regulator (LDO) used in the conventional art. Therefore, the system is more stable and has a lower decay so that it can be used in a longer cable. Moreover, in the present invention, the voltage is raised in the transmitting end so that the transmission lose is reduced, and thus the present invention is suitable to be used in the transmission of longer distance. From an experiment with an input voltage of 26V, full load condition and 70 m Ethernet cable, the present invention has a minimum power efficiency of 75%. Comparing with the prior art for entire remoter power and full load condition, the efficiency has a maximum value of only 41%. In general, the prior art using lower drop out regulating is only suitable to be used with cable of less 20 m. However, this is unrealistic currently.

Furthermore, in above example, the cable 5 may be an Internet cable, Ethernet cable, or other network system. The voltage output from the wire case 2 is not limited to 24V, other value below 40V suitable can be used in the present invention.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A power and signal common transmission device comprising a power adapter, a wire case, a transmission cable and a switching regulator, wherein
the power adapter serves for transforming alternative current input power into direct current output power, and power adapter has an input end for inputting AC power and an output end for output DC power;
the wire case serves for transforming the power wire from the power adapter into an output pins which are originally used for signal bus wires, the wire case has two input ends, one for signal input, and the other for power input, and an output end being connected to the cable for transmission;
the cable is connected from the wire case to the switching regulator; and
the switching regulator serves for dividing power and signal transmission path and decreasing a voltage of the input power; the switching regulator having an input from the cable and two output ends, one for power transmission and one for signal transmission.

2. The power and signal common transmission device as claimed in claim 1, wherein the cable is an Internet cable for using in Internet.

3. The power and signal common transmission device as claimed in claim 1, wherein the cable is an Ethernet cable for using in Ethernet.
